(19) United States
(12) Patent Application Publication
(10) Pub. No.: US 2013/0203410 A1
(43) Pub. Date: Aug. 8, 2013

(54) SYSTEMS AND METHODS FOR CREATING AND MAINTAINING A DATABASE OF COMMUNICATION SYSTEMS

(71) Applicant: QUALCOMM INCORPORATED, San Diego, CA (US)

(72) Inventors: Manasi D. GANDHI, San Diego, CA (US); Arvind SWAMINATHAN, San Diego, CA (US)

(73) Assignee: QUALCOMM INCORPORATED, San Diego, CA (US)

(21) Appl. No.: 13/762,360

(22) Filed: Feb. 7, 2013

Related U.S. Application Data
(60) Provisional application No. 61/596,531, filed on Feb. 8, 2012.

(51) Int. Cl. H04W 48/16

(52) U.S. Cl. CPC H04W 48/16
USPC 455/434

(57) ABSTRACT

A method for creating and maintaining a database of communication systems by a wireless communication device is described. The method includes detecting one or more other communication systems while connected to a first communication system. The method also includes populating a database with system information corresponding to the first communication system and the one or more other communication systems. The database includes a mapping between the first communication system and the one or more other communication systems. The method additionally includes determining a second communication system to search for based on the database and a connection to the first communication system.

### RELATED APPLICATIONS

This application is related to and claims priority from U.S. Provisional Patent Application Ser. No. 61/596,531, filed Feb. 8, 2012, for “Optimized System Selection.”

### TECHNICAL FIELD

The present disclosure relates generally to communication systems. More specifically, the present disclosure relates to systems and methods for creating and maintaining a database of communication systems.

### BACKGROUND

Communication systems are widely deployed to provide various types of communication content such as data, voice, video and so on. These systems may be multiple-access systems capable of supporting simultaneous communication of multiple communication devices (e.g., wireless communication devices, access terminals, etc.) with one or more other communication devices (e.g., base stations, access points, etc.). Some communication devices (e.g., access terminals, laptop computers, smart phones, media players, gaming devices, etc.) may wirelessly communicate with other communication devices.

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices.

As wireless communication devices have become more widely deployed, the number of communication systems available has also increased. However, inefficiencies may arise when searching for communication systems. Accordingly, systems and methods that may help to reduce these inefficiencies may be beneficial.

### SUMMARY

A method for creating and maintaining a database of communication systems by a wireless communication device is described. The method includes detecting one or more other communication systems while connected to a first communication system. The method also includes populating a database with system information corresponding to the first communication system and the one or more other communication systems. The database includes a mapping between the first communication system and the one or more other communication systems. The method further includes determining a second communication system to search for based on the database and a connection to the first communication system.

The method may also include detecting an event while camped on a first communication system. The method may further include determining the system information based on the event. The method may additionally include determining the mapping between the first communication system and the one or more other communication systems based on the system information. The event may include at least one of receiving a neighbor list message, redirection from a communication system, cell reselection from a communication system, a better system reselection scan, a high priority system scan, a connected mode handover, a silent redial scan, an off-frequency scan, an acquisition scan and concurrent camping on two systems.

The system information may include a frequency and a radio access technology for the first communication system and a frequency and a radio access technology for the one or more other communication systems found during an event. The system information may also include at least one of a band, whether a communication system is an evolved packet core system, a radio access technology of a communication system, a timestamp and an association probability.

The method may also include determining an association probability for each mapping in the database. The association probability may be related to a number of samples collected that support the mapping. The wireless communication device may access the first communication system using a first subscription and the one or more other communication systems using a second subscription.

The first communication system may include a voice communication system and at least one or more other communication systems may include data communication systems or voice communication systems. The first communication system may also include a data communication system and at least one or more other communication systems may include data communication systems or voice communication systems.

The method may also include maintaining the database on the wireless communication device indefinitely. Determining the second communication system to search for based on the database and a connection to the first communication system may include searching the database for the first communication system. Determining the second communication system to search for based on the database and a connection to the first communication system may also include determining one or more encountered communication systems based on the database. Determining the second communication system to search for based on the database and a connection to the first communication system may further include prioritizing a scan for the second communication system based on the encountered communication systems.

A wireless communication device for creating and maintaining a database of communication systems is also described. The wireless communication device includes system detection circuitry that detects one or more other communication systems while connected to a first communication system. The wireless communication device also includes database population circuitry coupled to the system detection circuitry. The database population circuitry populates a database with system information corresponding to the first communication system and the one or more other communication systems. The database includes a mapping between the first communication system and the one or more other communication systems. The wireless communication device further includes system search determination circuitry that determines a second communication system to search for based on the database and a connection to the first communication system.

A computer-program product for creating and maintaining a database of communication systems is also described. The computer-program product includes a non-transitory tangible computer-readable medium with instructions. The instructions include code for causing a wireless communication device to detect one or more other communication systems while connected to a first communication system. The instructions also include code for causing the wireless communication device to populate a database with system information corresponding to the first communication system and the one or more other communication systems. The database includes a mapping between the first communication system and the one or more other communication systems. The instructions further include code for causing the wireless communication device to determine a second communication system to search for based on the database and a connection to the first communication system.

An apparatus for creating and maintaining a database of communication systems is also described. The apparatus includes means for detecting one or more other communication systems while connected to a first communication system. The apparatus also includes means for populating a database with system information corresponding to the first communication system and the one or more other communication systems. The database includes a mapping between the first communication system and the one or more other communication systems. The apparatus further includes means for determining a second communication system to search for based on the database and a connection to the first communication system.

### BRIEF DESCRIPTION OF THE DRAWINGS

FIG. 1 is a block diagram illustrating one configuration of a wireless communication device and one or more communication systems in which systems and methods for creating and maintaining a database of communication systems may be implemented;

FIG. 2 is a flow diagram illustrating one configuration of a method for creating and maintaining a database of communication systems;

FIG. 3 is a diagram illustrating an example of mappings between communication systems;

FIG. 4 is a diagram illustrating one configuration of a wireless communication device and one or more communication systems in which systems and methods for creating and maintaining a database of communication systems may be implemented;

FIG. 5 is a block diagram illustrating an example of a wireless communication device that is in communication with a first communication system and a second communication system;

FIG. 6 is a block diagram illustrating another configuration of a wireless communication device and one or more communication systems in which systems and methods for creating and maintaining a database of communication systems may be implemented;

FIG. 7 is a flow diagram illustrating another configuration of a method for creating and maintaining a database of communication systems;

FIG. 8 is a flow diagram illustrating a configuration of a method for determining a second communication system to search for;

FIG. 9 is a block diagram illustrating various types of connectivity between a wireless communication device and a core network that the wireless communication device may utilize for data services and/or voice services;

FIG. 10 is a block diagram illustrating one configuration of a wireless communication device in which systems and methods for creating and maintaining a database of communication systems may be implemented; and

FIG. 11 illustrates certain components that may be included within a wireless communication device.

### DETAILED DESCRIPTION

Examples of communication devices include cellular telephone base stations or nodes, access points, wireless gateways and wireless routers. A communication device may operate in accordance with certain industry standards, such as Third Generation Partnership Project (3GPP) Long Term Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, IEEE 802.16 (e.g., Worldwide Interoperability for Microwave Access or “WiMAX”) standards, Code Division Multiple Access (CDMA) 2000 1x (referred to herein as “1x”, may also be referred to as IS-2000 or 1xRTT) standards, Evolution-Data Optimized (EVDO) standards, Interim Standard 95 (IS-95), High Rate Packet Data (HRPD), evolved High Rate Packet Data (eHRPD) radio standards and others. In some standards, a communication device may be referred to as a Node B, evolved Node B, etc. While some of the systems and methods disclosed herein may be described in terms of one or more standards, this should not limit the scope of the disclosure, as the systems and methods may be applicable to many systems and/or standards.

The 3rd Generation Partnership Project (3GPP) is a collaboration between groups of telecommunications associations that aims to define a globally applicable 3rd generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

Some communication devices (e.g., access terminals, client devices, client stations, etc.) may wirelessly communicate with other communication devices. Some communication devices (e.g., wireless communication devices) may be referred to as mobile devices, mobile stations, subscriber stations, clients, client stations, user equipment (UEs), remote stations, access terminals, mobile terminals, terminals, user terminals, subscriber units, etc. Additional examples of communication devices include laptop or desktop computers, cellular phones, smart phones, wireless modems, e-readers, tablet devices, gaming systems, etc. Some of these communication devices may operate in accordance with one or more industry standards as described above. Thus, the general term “communication device” may include communication devices described with varying nomenclatures according to industry standards (e.g., access terminal, user equipment, remote terminal, access point, base station, Node B, evolved Node B, etc.).

The terms “networks” and “systems” are often used interchangeably. A CDMA network may implement a radio access technology (RAT) such as Universal Terrestrial Radio Access (UTRA), CDMA2000, etc. UTRA includes W-CDMA and Low Chip Rate (LCR) while CDMA2000 covers IS-2000, IS-95 and IS-856 standards. A TDMA network may implement a radio access technology (RAT) such as Global System for Mobile Communications (GSM). An orthogonal frequency division multiple access (OFDMA) network may implement a radio access technology (RAT) such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). Additionally, CDMA2000 is described in documents from an organization named “3rd Generation Partnership Project 2” (3GPP2).

As used herein, the term “communication system” may refer to a system, a telecommunication system, a mobile telecommunication system, a network, a communication network, etc. Additionally, as used herein, the term “communication system” may refer to a radio access technology (RAT) that may be implemented within a particular communication system.

There are many situations in which the communication system selection procedures of a wireless communication device may benefit from knowledge of communication systems that are most likely to be found in a given location. For example, the systems and methods disclosed herein may improve communication system reselection, silent redial scans, emergency call scans, simultaneous voice and data (SV) performance and dual-subscriber-identity-module (SIM) dual-standby (DSDS) performance.

In one configuration, the systems and methods described herein include a database for communication system selection. The database may include information about available communication systems nearby. The database may be populated by recording any communication system that the wireless communication device encounters while connected to (e.g., camped on) the current communication system. For example, the wireless communication device may encounter other communication systems during acquisition scans, off-frequency scans, handoff, better system reselection (BSR) scans, silent redial scans, redirection, etc. The database may include system information such as radio access technologies (RATs) utilized by the communication systems. The database may additionally include a mapping between the current communication system and the other communication systems. The database may be maintained indefinitely (e.g., for life) on the wireless communication device.

The systems and methods described herein may be used to prioritize scans for nearby known good communication systems. Additionally, the systems and methods described herein may be used to find service sooner, improve call success rate, maintain data session (e.g., internet protocol (IP)) continuity and improve simultaneous voice and data (SV) performance.

The systems and methods described herein may be used to improve the chances of the wireless communication device finding service and maintaining IP continuity. For example, out-of-service (OOS) scans (also denoted as loss of service scans) may be prioritized. If the wireless communication device goes out-of-service while connected to an LTE communication system, for instance, the database may include a record of an available CDMA2000 1x communication system and collocated eHRPD communication system in the same or adjacent geographic area (GEO). The wireless communication device may prioritize the available communication systems during out-of-service (OOS) scans. Therefore, in this example, the wireless communication device may first scan for the eHRPD communication system, which provides a better chance for the wireless communication device to reestablish service and maintain data session continuity. The systems and methods described herein may also be used to improve most recently used (MRU) scans, better system reselection (BSR) scans, silent redial scans and emergency call scans.

It should be appreciated that the systems and methods described herein differ from other lists that may be used by the wireless communication device. For example, one list that may be used by the wireless communication device is a most recently used (MRU) list. However, the most recently used (MRU) list is merely a list and not a database. The most recently used (MRU) list only stores communication systems that the wireless communications device has connected to in the order the connection occurred. The most recently used (MRU) list is also only a linear list that does not contain mappings between communication systems.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods. Features and/or elements described in connection with a Figure may be combined with one or more features and/or elements described in connection with one or more other Figures.

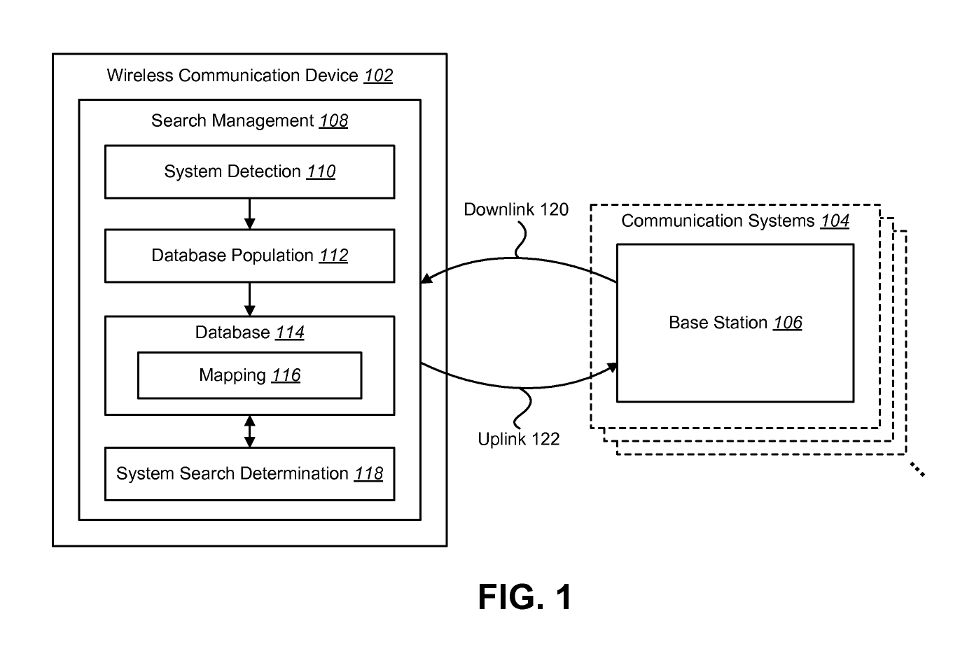

FIG. 1 is a block diagram illustrating one configuration of a wireless communication device 102 and one or more communication systems 104 in which systems and methods for creating and maintaining a database of communication systems 104 may be implemented. A base station 106 is a device that may communicate with one or more wireless communication devices 102. A base station 106 may also be referred to as, and may include some or all of the functionality of, an access point, a broadcast transmitter, a NodeB, an evolved NodeB (eNB), etc. Each base station 106 may provide communication coverage for a particular geographic area. A base station 106 may provide communication coverage for one or more wireless communication devices 102. The term “cell” may refer to a base station 106 and/or its coverage area depending on the context in which the term is used. Examples of the base station 106 include cellular phone base stations, access points, etc.

The wireless communication device 102 may also be referred to as, and may include some or all of the functionality of, a terminal, an access terminal, a subscriber unit, a station, a user equipment (UE), etc. Examples of the wireless communication device 102 may include a cellular phone, a personal digital assistant (PDA), a wireless device, a wireless modem, a handheld device, a laptop computer, a session initiation protocol (SIP) phone, a wireless local loop (WLL) station, etc.

A wireless communication device 102 may communicate with one or more base stations 106 on a downlink 120 and/or an uplink 122 at any given moment. The downlink 120 (or forward link) refers to the communication link from a base station 106 to a wireless communication device 102, and the uplink 122 (or reverse link) refers to the communication link from a wireless communication device 102 to a base station 106.

A wireless communication device 102 may be capable of communicating with the one or more base stations 106 as part of one or more communication systems 104. A communication system 104 may utilize one or more radio access technologies (RATs). Examples of radio access technologies (RATs) include CDMA2000 1x (also known as 1x), Global System for Mobile Communications (GSM), High Data Rate (HDR), High Rate Packet Data (HRPD), evolved High Rate Packet Data (eHRPD), Wideband Code Division Multiple Access (W-CDMA) and Long Term Evolution (LTE). One or more of the communication systems 104 may utilize different types of radio access technologies (RATs). For example, a first communication system 104 may utilize a radio access technology (RAT) that may include a Global System for Mobile Communications (GSM) network. In this example, a second communication system 104 may utilize a radio access technology (RAT) that may include a Long Term Evolution (LTE) network.

Communications between the wireless communication device 102 and base station 106 may be achieved through transmissions over a wireless link. Such a communication link may be established via a single-input and single-output (SISO), multiple-input and single-output (MISO) or a multiple-input and multiple-output (MIMO) system. A multiple-input and multiple-output system includes transmitter(s) and receiver(s) equipped, respectively, with multiple (N_{T}) transmit antennas and multiple (N_{R}) receive antennas for data transmission. Single-input and single-output and multiple-input and single-output systems are particular instances of a multiple-input and multiple-output system. The multiple-input and multiple-output system can provide improved performance (e.g., higher throughput, greater capacity or improved reliability) if the additional dimensionalities created by the multiple transmit and receive antennas are utilized.

The wireless communication device 102 may include a search management block/module 108. The search management block/module 108 may include a system detection block/module 110, a database population block/module 112, a database 114 with one or more mappings 116 and/or a system search determination block/module 118. As used herein, the term “block/module” may indicate that a particular element may be implemented in hardware, software, firmware or any combination thereof. For example, the search management block/module 108 may be implemented in hardware (e.g., circuitry), software or a combination of both. It should also be noted that one or more of the elements illustrated in FIG. 1 may be implemented in circuitry (e.g., integrated circuitry) in some configurations.

The system detection block/module 110 may detect one or more other communication systems 104 while the wireless communication device 102 is connected to a first communication system 104. In some configurations, the system detection block/module may be implemented as system detection circuitry coupled to the system detection circuitry. As used herein, the term “connect” and variations thereof in the context of communication may denote a wireless connection or link. The other communication systems 104 may utilize one or more radio access technologies (RATs). The other communication systems 104 detected by the system detection block/module 110 may utilize the same or different radio access technologies (RATs). Additionally, the radio access technology (RAT) of the first communication system 104 may be the same as or different than the radio access technologies (RATs) of the other communication systems 104 detected by the system detection block/module 110.

In one scenario (a voice-voice case), the first communication system 104 is a voice communication system (e.g., CDMA2000 1x) and the other communication system 104 is also a voice communication system (e.g., CDMA2000 1x, GSM, etc.). In another scenario (a voice-data case), the first communication system 104 is a voice communication system (e.g., CDMA2000 1x) and the other communication system 104 is a data communication system (e.g., LTE, HRPD, eHRPD, etc.). In yet another scenario (a data-voice case), the first communication system 104 is a data communication system (e.g., LTE) and the other communication system 104 is a voice communication system (e.g., CDMA2000 1x, GSM, etc.). In another scenario (a data-data case), the first communication system 104 is a data communication system (e.g., LTE) and the other communication system 104 is also a data communication system (e.g., LTE, HRPD, eHRPD, etc.).

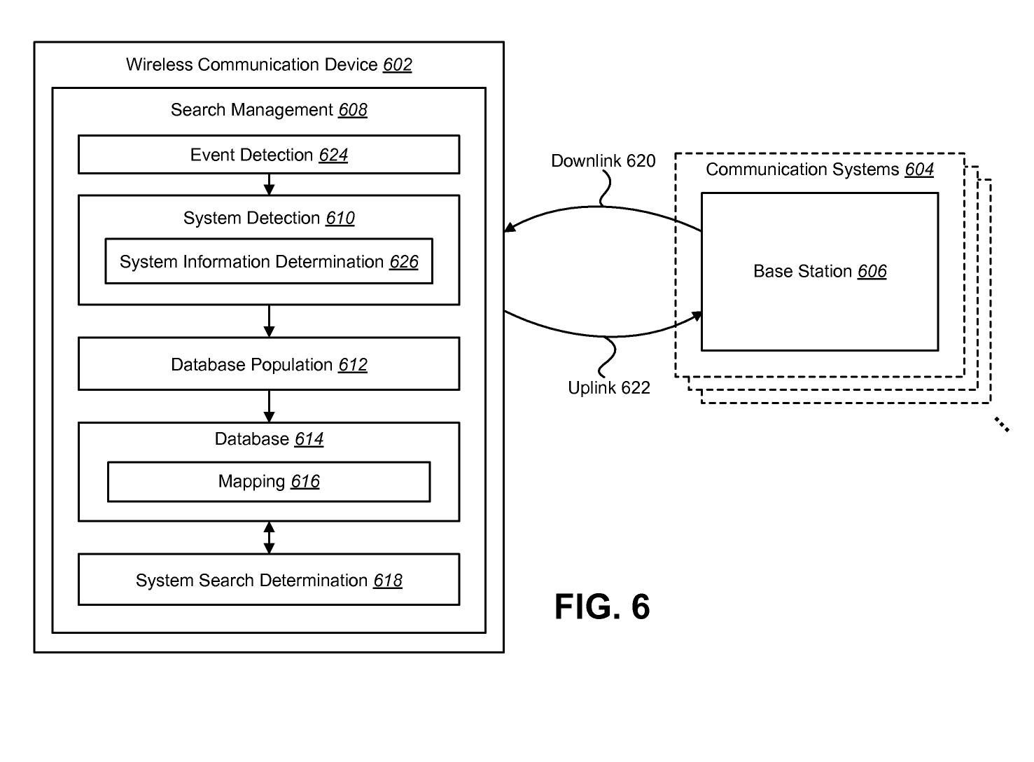

In some configurations, the system detection block/module 110 may detect the other communication systems 104 based on events. For example, the events may include receiving a neighbor list message, redirection from a communication system, cell reselection from a communication system, a better system reselection scan, a high priority scan, a connected mode handover, a silent redial scan, an off-frequency scan, an acquisition scan and/or concurrent camping on two or more systems. These events will be discussed in more detail in connection with FIG. 6.

Upon the occurrence of an event, the system detection block/module 110 may detect the other communication systems 104. In one configuration, the system detection block/module 110 may determine system information corresponding to the other communication systems 104 that may be detected. For example, the system information may include a frequency and a radio access technology (RAT) for the first communication system 104 and a frequency and a radio access technology (RAT) for the one or more other communication systems 104 found during an event. In one scenario, the system detection block/module 110 may determine system information during an ongoing event (such as a better system reselection scan, a high priority scan, a silent redial scan, an off-frequency scan, an acquisition scan, concurrent camping on two systems, etc.).

In some configurations, the system detection block/module 110 may additionally determine whether a detected communication system 104 may be available (e.g., useable) to the wireless communication device 102. Upon detecting other communication systems 104, the system detection block/module 110 may determine whether the wireless communication device 102 may establish a connection with the other communication systems 104. For example, the system detection block/module 110 may determine whether the other communication systems 104 may be compatible with the wireless communication device 102 as indicated by the frequency and/or radio access technology (RAT). In one configuration, the system detection block/module 110 may determine if a communication system 104 is useable based on whether the detected (e.g., neighboring) communication system 104 has a chip-energy-to-total-interference ratio (E_{c}/I₀) above a threshold (e.g., −6 dB to −8 dB for CDMA). The chip-energy-to-total-interference ratio (E_{c}/I₀) threshold may indicate whether the detected communication system 104 is a useable communication system 104.

The database population block/module 112 may populate a database 114 with system information. In some configurations, the database population block/module 112 may be implemented as database population circuitry. The system information may correspond to the communication system 104 that the wireless communication device 102 is connected to (e.g., the first communication system 104) and the other communication system(s) 104 detected by the system detection block/module 110. In one configuration, the system information may include the frequency and radio access technology (RAT) of the communication systems 104. For example, the database population block/module 112 may populate the database 114 with the frequency (e.g., radio frequency) and the radio access technology (RAT) that the wireless communication device 102 may use to communicate with the base station 106 in the first communication system 104. The database population block/module 112 may also populate the database 114 with the one or more frequencies and the one or more radio access technologies (RATs) of the other communication systems 104 detected by the system detection block/module 110. The database 114 may be implemented in memory.

The database population block/module 112 may also populate the database 114 with additional system information. For example, the database population block/module 112 may populate the database 114 with information about the band used by a communication system 104 and/or whether a communication system 104 is an evolved packet core (EPC) or non-evolved packet core (non-EPC) system. The system information may additionally or alternatively include whether a communication system 104 is a third-generation (3G) or fourth-generation (4G) system. The system information may additionally or alternatively include a timestamp of when the other communication systems 104 were detected by the system detection block/module 110.

The database 114 may include a mapping 116 between the first communication system 104 and the other communication systems 104. The mapping 116 may be an association or relationship between communication systems. For example, the mapping 116 may be an association or relationship between the communication system 104 that the wireless communication device 102 is currently connected to (e.g., the first communication system 104) and the other communication systems 104 that may be detected by the system detection block/module 110. Therefore, the mapping 116 may indicate a geographic proximity of the first communication system 104 to the other communication systems 104. The mapping 116 may be determined based on the system information. For example, the database population block/module 112 may determine the mapping 116 based on the system information.

In one configuration, the mapping 116 may be a link between the first communication system 104 and the other communication system(s) 104 that the database population block/module 112 may create and/or enter into the database 114. Additionally or alternatively, the mapping 116 may be inferred from the information entered into the database 114. In one approach, the database 114 structure may indicate the mapping 116. For example, the database population block/module 112 may populate a row of the database 114 with system information for the first communication system 104 that may also include system information about the other communication systems 104. By populating the database 114 with a row or entry that includes the system information for the first communication system 104 together with the system information for the other communication systems 104, the wireless communication device 102 may map the communication systems 104 with each other. In other words, the mapping 116 may be a row or entry in the database 114 that includes system information for the connected communication system 104 (e.g., the first communication system 104) and system information for one or more other communication systems 104 detected by the system detection block/module 110.

The database population block/module 112 may additionally or alternatively populate the database 114 with one or more association probabilities. In one configuration, the database population block/module 112 may determine an association probability for each mapping 116 in the database 114. In some configurations, the association probability may be related to a number of collected samples that support the mapping 116. For example, if the association probability is equal to 1, the wireless communication device 102 has obtained enough samples to associate a high reliability of the association (e.g., the mapping 116). However, if the association probability is equal to 0.5, for instance, then the wireless communication device 102 does not have enough samples to assign a high reliability to the association.

In one configuration, the samples used to determine the association probability may be obtained each time the database population block/module 112 may populate (e.g., fill and/or update) the database 114. For example, the database population block/module 112 may populate the database 114 with system information corresponding to System A (the connected communication system 104) and System B (the detected communication system 104). A mapping 116 may be created in the database 114 between System A and System B based upon this entry. This instance of creating the mapping 116 between System A and System B may be one sample. As the database population block/module 112 creates additional entries in the database 114 with additional mappings 116 (additional samples) between System A and System B, the association probability for the mapping 116 between System A and System B may increase.

The system search determination block/module 118 may determine a second communication system 104 to search for based on the database 114 and a connection to the first communication system 104. In some configurations, the system search determination block/module 118 may be implemented as system search determination circuitry. For example, the system search determination block/module 118 may determine one or more prospective communication systems 104 to which the wireless communication device 102 may connect. The wireless communication device 102 may search for the one or more prospective communication systems 104. For example, the wireless communication device 102 may search for the second communication system by performing a better system reselection (BSR) scan, a most recently used (MRU) scan, a silent redial scan, and/or an emergency call scan. In some cases, the search may be used to determine whether the wireless communication device 102 may switch from the first communication system 104 to the second communication system 104. Additionally or alternatively, the wireless communication device 102 may start a handoff or may be redirected from the first communication system 104 to the second communication system 104. In one scenario, the wireless communication device 102 may currently be connected to the first communication system 104 while searching for a second communication system 104.

In another scenario, the wireless communication device 102 may be disconnected from the first communication system 104 and may search for a second communication system 104 with which to connect. For example, the wireless communication device 102 may go out-of-service (OOS), or lose its connection with the first communication system 104. In this scenario, the wireless communication device 102 may maintain a record that the first communication system 104 was the last communication system 104 to which the wireless communication device 102 was connected. The system search determination block/module 118 may determine a second communication system 104 to search for based on the record that the wireless communication device 102 was last connected to the first communication system 104.

The system search determination block/module 118 may query the database 114 to determine whether the wireless communication device 102 may have encountered other communication systems 104 while connected to the first communication system 104. In one configuration, the system search determination block/module 118 may send a query to the database 114 requesting information about the encountered communication systems 104. The database 114 may refer to the mapping 116 to determine whether the wireless communication device 102 may have encountered other communication systems 104 while connected to the first communication system 104. If the mapping 116 indicates that one or more encountered communication systems 104 exist, the database 114 may send system information about the encountered communication systems 104 to the system search determination block/module 118. Additionally or alternatively, if the mapping 116 indicates that wireless communication device 102 may not have encountered other communication systems 104 while connected to the first communication system 104, or if no mapping 116 and/or entries in the database 114 exist for the first communication system 104, the database 114 may inform the system search determination block/module 118 that no encountered communication systems 104 exist.

The system search determination block/module 118 may prioritize a search for the second communication system 104 based on the query results from the database 114. For example, if the query results indicate that there are encountered communication systems 104, then the system search determination block/module 118 may base the search for the second communication system 104 upon the encountered communication systems 104. In other words, the system search determination block/module 118 may determine that the wireless communication device 102 may search for one or more communication systems 104 that were previously encountered while connected to the first communication system 104 before conducting a broad search for available communication systems 104. Additionally or alternatively, the system search determination block/module 118 may prioritize a search for the second communication system 104 based on the association probability. For example, a communication system 104 with a higher association probability may be given a higher priority in a search for the second communication system 104 than a communication system 104 with a lower association probability.

In addition to the benefits previously described, the systems and methods described herein may result in beneficial power savings. For example, by managing (e.g., prioritizing) the search for the second communication system 104, the wireless communication device 102 may not waste time and power searching for communication systems 104 that are not likely to be found.

Additionally, the systems and methods described herein may result in improved performance due to data continuity (e.g., internet protocol (IP) continuity). In one example, a wireless communication device 102 may have an active data session while connected to an LTE communication system 104. If the wireless communication device 102 loses connectivity with the LTE communication system 104, then the wireless communication device 102 may prioritize a search for a communication system 104 that may provide data continuity with the LTE communication system 104. For instance, the wireless communication device 102 may have a mapping 116 between the LTE communication system 104 and an eHRPD communication system 104, which may maintain data continuity. Therefore, the wireless communication device 102 may maintain the active data session without having to disconnect and reconnect the data session.

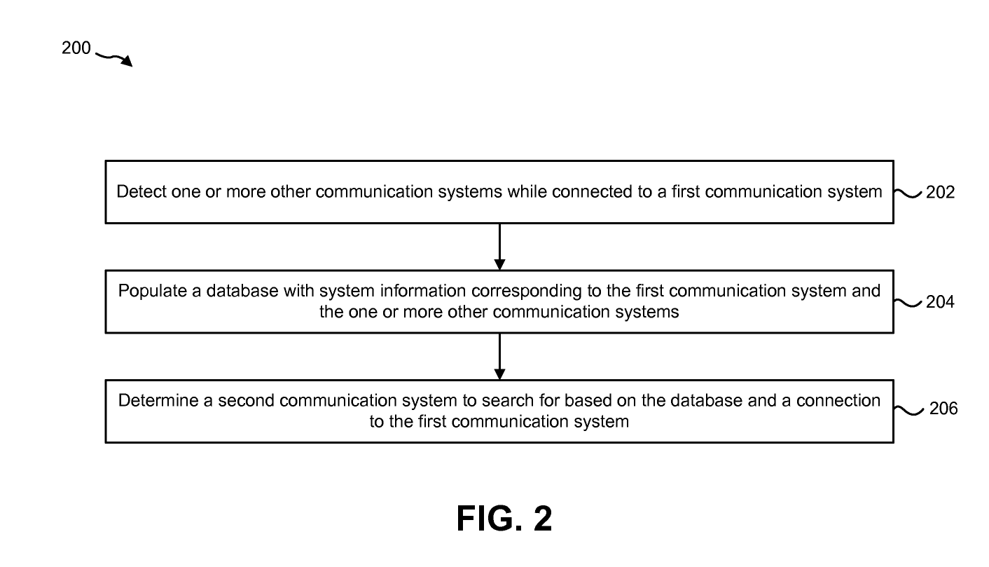

FIG. 2 is a flow diagram illustrating one configuration of a method 200 for creating and maintaining a database of communication systems 104. The method 200 may be performed by a wireless communication device 102. For example, the method 200 may be performed by a search management block/module 108. The wireless communication device 102 may detect 202 one or more other communication systems 104 while the wireless communication device 102 is connected to (e.g., camped on) a first communication system 104. The other communication systems 104 may utilize one or more radio access technologies (RATs). The other communication systems 104 detected 202 by the wireless communication device 102 may utilize the same or different radio access technologies (RATs). Additionally, the radio access technology (RAT) of the first communication system 104 may be the same as or different than the radio access technologies (RATs) of the other communication systems 104 detected 202 by the wireless communication device 102.

In some configurations, the wireless communication device 102 may detect 202 the other communication systems 104 based on events. Examples of events may include receiving a neighbor list message, redirection from a communication system, cell reselection from a communication system, a better system reselection scan, a high priority scan, a connected mode handover, a silent redial scan, an off-frequency scan, an acquisition scan and/or concurrent camping on two or more systems. These events will be discussed in more detail in connection with FIG. 6. Upon the occurrence of an event, the wireless communication device 102 may detect 202 the other communication systems 104. In one configuration, the wireless communication device 102 may determine system information corresponding to the other communication systems 104 that may be detected 202.

In one configuration, the wireless communication device 102 may additionally determine whether a detected communication system 104 may be available (e.g., useable) to the wireless communication device 102. Upon detecting 202 other communication systems 104, the wireless communication device 102 may determine whether the wireless communication device 102 may establish a connection with the other communication systems 104. For example, the wireless communication device 102 may determine whether the other communication systems 104 may be compatible with the wireless communication device 102 as indicated by the frequencies and radio access technologies (RATs) of the other communication systems 104. In one configuration, the wireless communication device 102 may determine if a communication system 104 is useable based on whether the detected communication system 104 has a chip-energy-to-total-interference ratio (E_{C}/I₀) above a threshold (e.g., −6 dB to −8 dB for CDMA).

The wireless communication device 102 may populate 204 (e.g., fill and/or update) a database 114 with system information corresponding to the first communication system 104 and the one or more other communication systems 104. In one configuration, the system information may include the frequency and radio access technology (RAT) of the communication systems 104. For example, the wireless communication device 102 may populate 204 the database 114 with the frequency (e.g., radio frequency) and the radio access technology (RAT) that the wireless communication device 102 may use to communicate with the base station 106 in the first communication system 104. The wireless communication device 102 may also populate 204 the database 114 with the one or more frequencies and the one or more radio access technologies (RATs) of the other communication systems 104 detected 202 by the wireless communication device 102.

In some configurations, the wireless communication device 102 may also populate 204 the database 114 with additional system information. For example, the wireless communication device 102 may populate 204 the database 114 with information about the band (e.g., frequency band) used by a communication system 104 and/or whether a communication system 104 is an evolved packet core (EPC) or non-evolved packet core (non-EPC) system. The system information may additionally or alternatively indicate whether a communication system 104 is a third-generation (3G) or fourth-generation (4G) system. In some configurations, the system information may additionally or alternatively include a timestamp of when the other communication systems 104 were detected 202 by the wireless communication device 102.

The database 114 may include a mapping 116 between the first communication system 104 and the other communication systems 104. The mapping 116 may be an association or relationship between communication systems. For example, the mapping 116 may be an association or relationship between the communication system 104 that the wireless communication device 102 is currently connected to (e.g., the first communication system 104) and the other communication systems 104 that may be detected by the wireless communication device 102. Therefore, the mapping 116 may indicate geographic proximity of the first communication system 104 to the other communication systems 104.

In one configuration, the mapping 116 may be a link between the first communication system 104 and the other communication system(s) 104 that the wireless communication device 102 may create and/or enter into the database 114. For example, the mapping 116 may be an entry in the database 114 that includes system information for the connected communication system 104 (e.g., the first communication system 104) and system information for one or more other communication systems 104 detected by the wireless communication device 102. Additionally or alternatively, the mapping 116 may be inferred from the information entered into the database 114. For example, the database 114 structure may indicate the mapping 116.

The wireless communication device 102 may additionally or alternatively populate 204 the database 114 with one or more association probabilities. In one configuration, the wireless communication device 102 may determine an association probability for each mapping 116 in the database 114. In some configurations, the association probability may be related to a number of collected samples that support the mapping 116. The samples used to determine the association probability may be obtained each time the wireless communication device 102 may populate 204 the database 114.

The wireless communication device 102 may determine 206 a second communication system 104 to search for based on the database 114 and a connection to the first communication system 104. The connection may be a current (e.g., ongoing) connection or a prior connection. More specifically, the wireless communication device 102 may determine 206 one or more prospective communication systems 104 to which the wireless communication device 102 may connect. The wireless communication device 102 may search for the one or more prospective communication systems 104. For example, the wireless communication device 102 may search for the second communication system by performing a better system reselection (BSR) scan, a most recently used (MRU) scan, a silent redial scan, and/or an emergency call scan. In some cases, the search may be used to determine whether the wireless communication device 102 may switch from the first communication system 104 to the second communication system 104. Additionally or alternatively, the wireless communication device 102 may start a handoff or may be redirected from the first communication system 104 to the second communication system 104. In one scenario, the wireless communication device 102 may currently be connected to the first communication system 104 and may search for a second communication system 104.

In another scenario, the wireless communication device 102 may be disconnected from the first communication system 104 and may search for a second communication system 104 with which to connect. In this scenario, the wireless communication device 102 may maintain a record that the first communication system 104 was the last (e.g., most recent) communication system 104 to which the wireless communication device 102 was connected. The wireless communication device 102 may determine 206 a second communication system 104 to search for based on the record that the wireless communication device 102 was last connected to the first communication system 104.

The wireless communication device 102 may query the database 114 to determine whether the wireless communication device 102 may have encountered other communication systems 104 while connected to the first communication system 104. The database 114 may refer to the mapping 116 to determine whether the wireless communication device 102 may have encountered other communication systems 104 while connected to the first communication system 104. If the mapping 116 indicates that one or more encountered communication systems 104 exist, the database 114 may send system information about any encountered communication systems 104 to the wireless communication device 102.

The wireless communication device 102 may prioritize a search for the second communication system 104 based on the query results from the database 114. For example, if the query results indicate that there are encountered communication systems 104, then the wireless communication device 102 may determine 206 the second communication system 104 to search for based upon the encountered communication systems 104. In other words, the wireless communication device 102 may determine that it may search for one or more communication systems 104 that were previously encountered while connected to the first communication system 104 before conducting a broad search for available communication systems 104. Additionally or alternatively, the wireless communication device 102 may prioritize a search for the second communication system 104 based on the association probability.

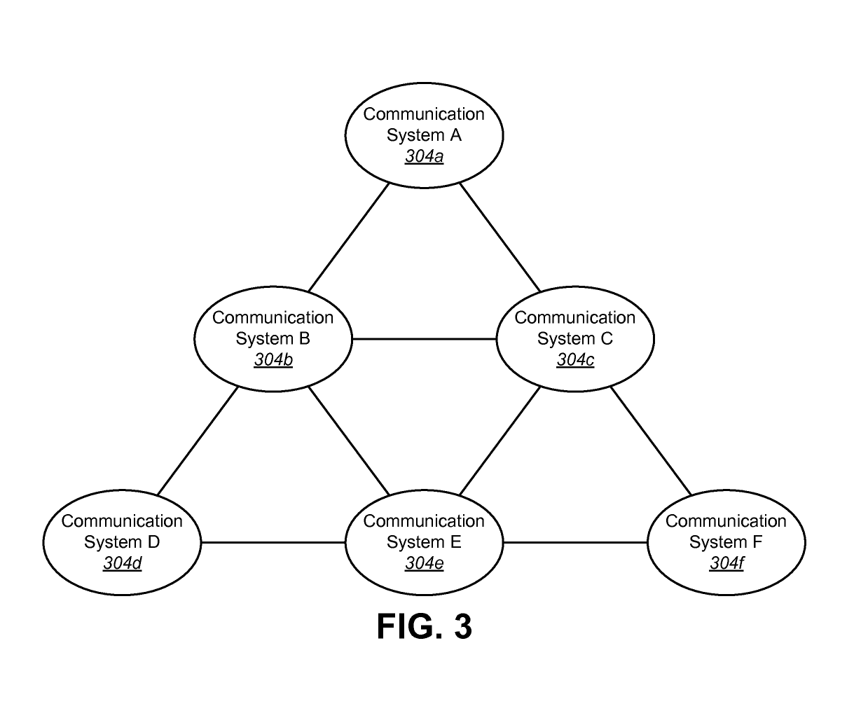

FIG. 3 is a diagram illustrating an example of mappings 116 between communication systems 304. In this example, communication systems 304a-f are connected by lines representing associations or relationships between the communication systems 304a-f. The associations indicate that a wireless communication device 102 may detect or connect to (e.g., camp on) a second communication system 304 from a first communication system 304. The mappings 116 may be included in a database 114.

In one scenario, a wireless communication device 102 may be connected to communication system A 304a. While connected to communication system A 304a, the wireless communication device 102 may detect communication system B 304b and communication system C 304c as indicated by the connected association lines. However, the wireless communication device 102 may not detect the remaining communication systems 304d-e while connected to communication system A 304a. Therefore, the mapping 116 stored in the database 114 for communication system A 304a would include communication system B 304b and communication system C 304c.

In another scenario, if the wireless communication device 102 may be connected to communication system B 304b, the wireless communication device 102 may detect communication systems A 304a, C 304c, D 304d and E 304e as indicated by the connected association lines. Therefore, the mapping 116 stored in the database 114 for communication system B 304b would include communication systems A 304a, C 304c, D 304d and E 304e.

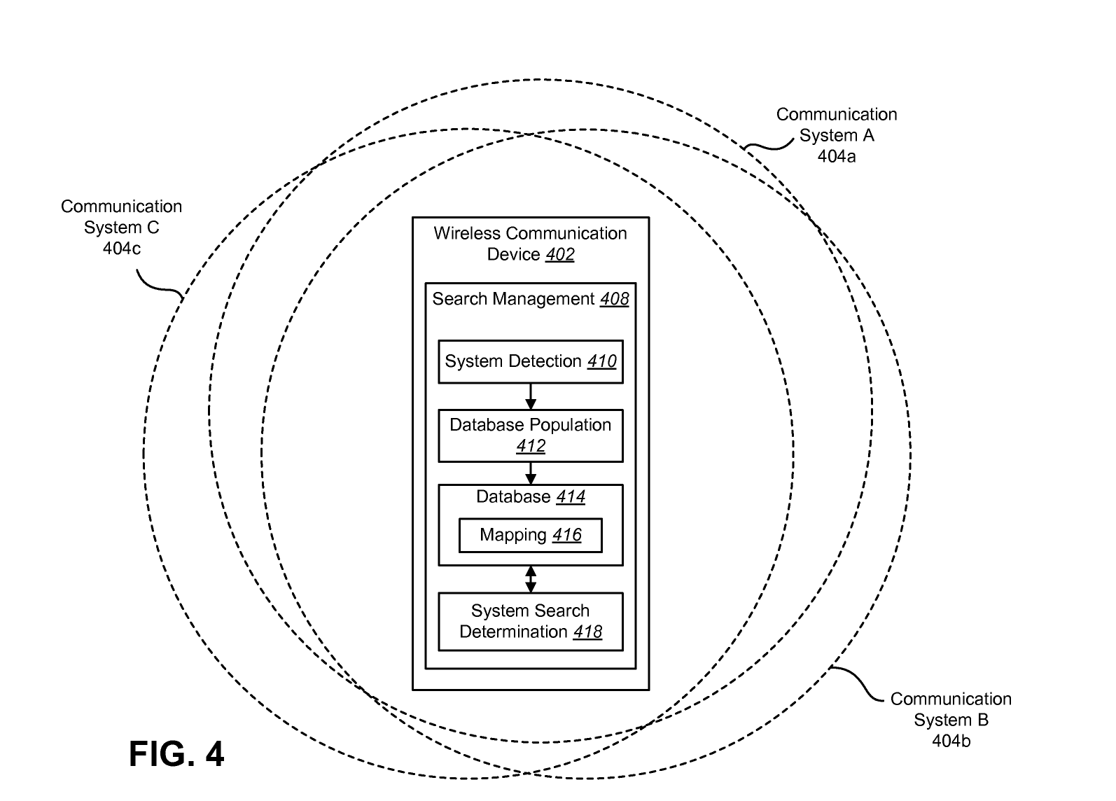

FIG. 4 is a diagram illustrating one configuration of a wireless communication device 402 and one or more communication systems 404a-c in which systems and methods for creating and maintaining a database of communication systems 404 may be implemented. For example, the wireless communication device 402 may include a search management block/module 408 for creating and maintaining a database of communication systems 404. The wireless communication device 402 may be similar to the wireless communication device 102 described in connection with FIG. 1. The dashed lines in FIG. 4 indicate the coverage areas of the communication systems 404a-c. While FIG. 4 depicts three communication systems 404a-c, any number of communication systems 404 may be available.

One or more communication systems 404a-c may be available to the wireless communication device 402. A communication system 404 may include a coverage area, which is a geographic region where a communication system 404 may communicate with the wireless communication device 402. For example, a communication system 404 may utilize a radio access technology (RAT) to provide a network link between the wireless communication device 402 and a base station 106. The communication systems 404a-c may utilize different types of radio access technologies (RATs). For example, the radio access technology (RAT) for communication system A 404a may be Global System for Mobile Communication (GSM). The radio access technology (RAT) for communication system B 404b may be CDMA2000 1x (1x). The radio access technology (RAT) for communication system C 404c may be Long Term Evolution (LTE).

In one scenario, the wireless communication device 402 may be connected to communication system A 404a. The system detection block/module 410 may detect the other communication systems 404b-c. The database population block/module 412 may populate a database 414 with system information corresponding to communication system A 404a. The database population block/module 412 may also populate the database 414 with system information corresponding to the other detected communication systems B 404b and C 404c. The database 414 may include a mapping 416 between communication system A 404a and the other communication systems B 404b and C 404c.

The system search determination block/module 418 may determine a communication system 404 to search for based on the database 414 and the connection to communication system A 404a. The system search determination block/module 418 may query the database 414 to determine which communication systems 404 may map to communication system A 404a. In this scenario, the mapping 416 indicates that communication system B 404b and communication system C 404c map to communication system A 404a. Therefore, the system search determination block/module 418 may determine that communication system B 404b and communication system C 404c may be given priority in a subsequent search for a communication system 404 with which to connect.

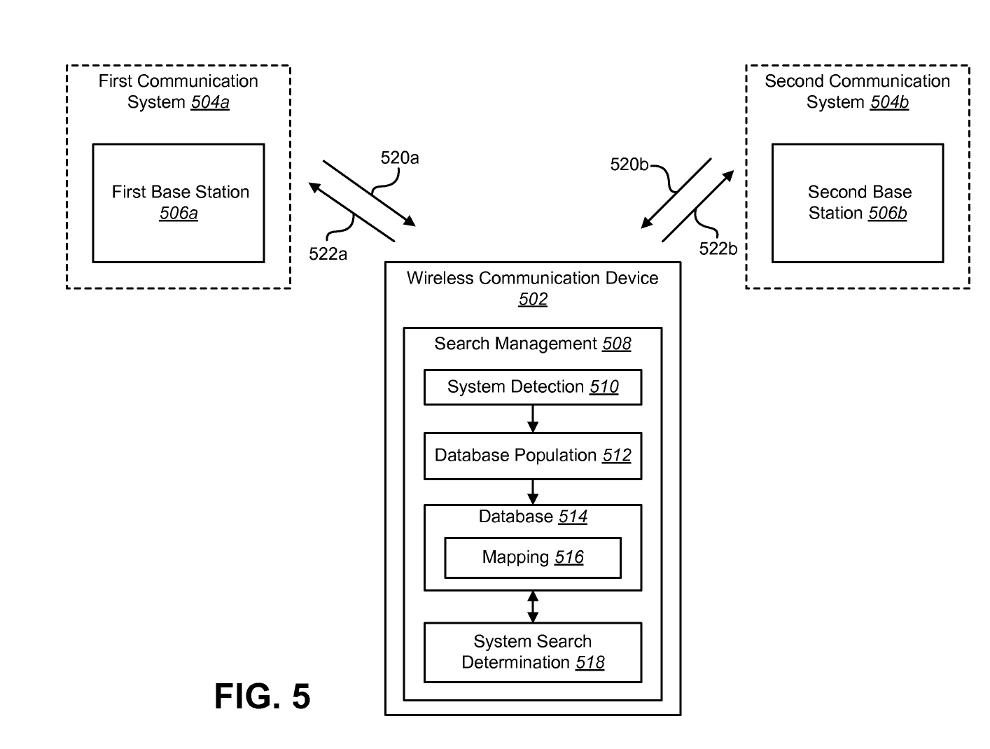

FIG. 5 is a block diagram illustrating an example of a wireless communication device 502 that is in communication with a first communication system 504a and a second communication system 504b. In some configurations, the wireless communication device 502 may be simultaneously connected to both the first communication system 504a and the second communication system 504b. The wireless communication device 502 may include a search management block/module 508 for creating and maintaining a database of communication systems 504 as described by the systems and methods described herein.

In one configuration, the wireless communication device 502 may be a dual-subscriber-identity-module (SIM), dual-standby (DSDS) device. In this configuration, the wireless communication device 502 may have two subscriptions and may get service on two communication systems 504a-b simultaneously. For example, the wireless communication device 502 may connect to the first communication system 504a by communicating with a first base station 506a on a downlink 520a and/or an uplink 522a. The wireless communication device 502 may also connect to the second communication system 504b by communicating with a second base station 506b on a downlink 520b and/or an uplink 522b. In one configuration, the wireless communication device 502 may include a system detection block/module 510 that may detect the second communication system 504b while the wireless communication device 502 is connected to a first communication system 504a.

The wireless communication device 502 may include a database 514 and may use the database 514 when searching for communication systems 504. In one scenario, the wireless communication device 502 may be connected to the first communication system 504a based on a first subscription while simultaneously performing out-of-service scans on the second communication system 504b based on a second subscription. In this scenario, the wireless communication device 502 may use the database 514 to prioritize the bands, channels, and communication systems 504 that it searches for (e.g., scans) on the second subscription.

As one example, the database 514 may be populated (by a database population block/module 512, for instance) with system information as illustrated in Table 1.

TABLE 1

| Communi- | | Communi- | | |
|---|---|---|---|---|
| cation | | cation | | |
| System on | Channel on | System on | Channel on | |
| Subscrip- | Subscrip- | Subscrip- | Subscrip- | Time- |
| tion 1 | tion 1 | tion 2 | tion 2 | stamp |
| PLMN1 | 800_CH1 | PLMN2 | 800_CH3, | Time 1 |
| | | | 1900_CH4 | |
| PLMN1 | 800_CH2 | 1x S1/N3 | BC1_CH1 | Time 2 |
| PLMN1 | 800_CH1 | 1x S1/N3 | PCS_CH4 | Time 3 |
| PLMN3 | 1800_CH4 | 1x S1/N3 | PCS_CH4 | Time 4 |
| . . . | . . . | . . . | . . . | . . . |

In this example, the wireless communication device 502 may currently be connected to communication system PLMN1 (Public Land Mobile Network 1) in channel 800_CH1 on the first subscription. The wireless communication device 502 may query (by the system search determination block/module 518, for instance) the database 514 to find that the wireless communication device 502 previously found service on communication system PLMN2 in channels 800_CH3 and 1900_CH4 at time 1 and communication system 1xS1/N3 in channel PCS_CH4 at time 3 while connected to communication system PLMN1 in channel 800_CH1. Therefore, the mapping 516 for communication system PLMN1 in channel 800_CH1 includes communication system PLMN2 in channels 800_CH3 and 1900_CH4 and communication system 1x S1/N3 in channel PCS_CH4.

Using this information, the wireless communication device 502 may prioritize an out-of-service scan of the second subscription by first searching on the communication systems 504 and channels where the wireless communication device 502 previously found service while connected to the current communication system 504 and channel of the first subscription. In other words, in this example, the wireless communication device 502 may first search on communication system PLMN2 in channels 800_CH3 and 1900_CH4 and communication system 1x S1/N3 in channel PCS_CH4. The wireless communication device 502 may, for example, insert these communication systems 504 and channels (communication system PLMN2 in channels 800_CH3 and 1900_CH4 and communication system 1x S1/N3 in channel PCS_CH4) into an out-of-service scan list at a regular interval (e.g., once every minute). This will result in these communication systems 504 and channels being scanned at a higher rate.

In another scenario, the wireless communication device 502 may perform a silent redial on the second subscription while connected to the first subscription. The wireless communication device 502 may use the database 514 for improving a silent redial list. In one example, suppose the database 514 may store the same information as shown above in Table 1, and the wireless communication device 502 may be connected to communication system PLMN1 in channel 800_CH1 on the first subscription. The wireless communication device 502 may query the database 514 to find that the wireless communication device 502 previously found service on communication system PLMN2 in channels 800_CH3 and 1900_CH4 and communication system 1x S1/N3 in channel PCS_CH4 while connected to communication system PLMN1 in channel 800_CH1. The wireless communication device 502 may use this information to prioritize the silent redial list. For example, the wireless communication device 502 may first redial on the second subscription using the communication systems 504 and channels where the wireless communication device 502 previously found service while connected to the current communication system and channel of the first subscription. In other words, in this example, the wireless communication device 502 may first silently redial on system PLMN2 in channels 800_CH3 and 1900_CH4 and system 1x S1/N3 in channel PCS_CH4.

In yet another scenario, the wireless communication device 502 may be a simultaneous voice and data (SV) device that has one radio to operate on a voice communication system 504 and a second radio to operate on a data communication system 504. For example, the wireless communication device 502 may have a radio for communicating on a CDMA2000 1x (voice) communication system 504 and a second radio for communicating on an LTE (data) communication system 504. In a common scenario, the wireless communication device 502 may be searching for an LTE communication system 504 while connected to a CDMA2000 1x communication system 504.

The database 514 may specify for each CDMA2000 1x communication system 504 in a preferred roaming list (PRL) the duration of time that the wireless communication device 502 was connected to each CDMA2000 1x communication system 504 in a last number of days. The number of days may be denoted as N_averaging.

The database 514 may further specify for each communication system 504 the amount of time that the wireless communication device 502 detected (e.g., acquired) an LTE communication system 504. If the time is greater than zero, the database 514 may further store the LTE communication system 504 and channel. In this scenario, the wireless communication device 502 may use the database 514 to improve out-of-service or better system reselection (BSR) scans for the LTE communication system 504. For example, the wireless communication device 502 may prioritize scanning on the LTE communication systems 504 and channels that the wireless communication device 502 previously detected (e.g., acquired) while connected to the current CDMA2000 1x system 504.

FIG. 6 is a block diagram illustrating another configuration of a wireless communication device 602 and one or more communication systems 604 in which systems and methods for creating and maintaining a database of communication systems 604 may be implemented. The one or more communication systems 604 may be similar to the one or more communication systems 104 described earlier. The one or more communication systems 604 may include one or more base stations 606 similar to the one or more base stations 106 described in connection with FIG. 1. The wireless communication device 602 may be similar to the wireless communication device 102 described in connection with FIG. 1. For example, the wireless communication device 602 may include a search management block/module 608 similar to the search management block/module 108 described in connection with FIG. 1.

Communications between the wireless communication device 602 and base station 606 may be achieved through transmissions over a wireless link. The wireless communication device 602 may communicate with the one or more base stations 606 on the downlink 620 and/or uplink 622 at any given moment. The downlink 620 and/or uplink 622 may be similar to corresponding elements described in connection with FIG. 1.

A wireless communication device 602 may be capable of communicating with the one or more base stations 606 utilizing one or more radio access technologies (RATs). In some implementations, the one or more radio access technologies (RATs) may be similar to the one or more radio access technologies (RATs) described in connection with FIG. 1.

The wireless communication device 602 may include system detection block/module 610, a database population block/module 612, a database 614 with one or more mappings 616 and/or a system search determination block/module 618 similar to corresponding elements described in connection with FIG. 1.

In some configurations, an event detection block/module 624 may be coupled to the system detection block/module 610. The event detection block/module 624 may be implemented as event detection circuitry coupled to the system detection circuitry. The event detection block/module 624 may detect one or more events while camped on a first communication system 604. Based on the one or more events, the event detection block/module 624 may direct the system detection block/module 610 to detect one or more other communication systems 604 while the wireless communication device 602 is connected to (e.g., camped on) a first communication system 604 as described above in connection with FIG. 1. The one or more events may include receiving a neighbor list message, redirection from a communication system, cell reselection from a communication system, a better system reselection scan, a high priority scan, a connected mode handover, a silent redial scan, an off-frequency scan, an acquisition scan and/or concurrent camping on two systems.

In one configuration, upon the event detection block/module 624 detecting an event, the system detection block/module 610 may determine system information corresponding to the other communication systems 604 that may be detected. For example, the system detection block/module 610 may include a system information determination block/module 626 that may determine system information based on the event. In some configurations, the system information determination block/module 626 may be implemented as system information determination circuitry coupled to the system detection circuitry. A database 614 may be populated with the system information by a database population block/module 612.

In one scenario, the event may be receiving a neighbor list message. In this scenario, the wireless communication device 602 may populate the database 614 with system information based on frequencies listed in the neighbor list message. For example, the database population block/module 612 may create or update records in the database 614 as described in Equation (1).

System X,Frequency Y→Frequency Z,RATA. (1)

In Equation (1), System X and Frequency Y may represent the communication system 604 and frequency to which the wireless communication device 602 is currently connected. Frequency Z and RAT A may represent the frequency and radio access technology (RAT) included in the neighbor list. The record may indicate a mapping 616 from System X and Frequency Y to Frequency Z and RATA.

In another scenario, the event may be a successful redirection from a first communication system 604 to a second communication system 604 (e.g., from an LTE communication system 604 to an evolved high-rate-packet-data (eHRPD) communication system 604). In this scenario, the database population block/module 612 may create or update records in the database 614 as described in Equation (2).

System X,Frequency Y→System A,Frequency B,RAT Z. (2)

In Equation (2), System X and Frequency Y may represent the communication system 604 that redirected and the frequency from which the wireless communication device 602 is redirected. System A, Frequency B, and RAT Z may represent the communication system 604, frequency, and radio access technology (RAT) to which the wireless communication device 602 is redirected. The record may indicate a mapping 616 from System X and Frequency Y to System A, Frequency B, and RAT Z.

In another scenario, the event may be a successful cell reselection from a first communication system 604 to a second communication system 604 (e.g., from an LTE communication system 604 to an eHRPD communication system 604). In this scenario, the database population block/module 612 may create or update records in the database 614 as described in Equation (3).

System X,Frequency Y→System A,Frequency B,RAT Z. (3)

In Equation (3), System X and Frequency Y may represent the communication system 604 system and frequency from which the wireless communication device 602 is reselected. System A, Frequency B, and RAT Z may represent the communication system 604, frequency, and radio access technology (RAT) to which the wireless communication device 602 is reselected. For example, the record may indicate a mapping 616 from System X and Frequency Y to System A, Frequency B, and RAT Z.

In yet another scenario, the event may be a better system reselection (BSR) scan. In this scenario, the wireless communication device 602 may create or update records in the database 614 using target communication systems 604 found during better system reselection (BSR) scanning The database population block/module 612 may create or update records in the database 614 that map the current communication system 604 (e.g., the first communication system 604) to the identified target communication systems 604. In this scenario, the wireless communication device 602 may perform a subsequent better system reselection (BSR) scan by using the mapping 616 of the current (e.g., source) communication system 604 to a target communication system 604. Therefore, a target communication system 604 may be prioritized (by the system search determination block/module 618, for instance) during a subsequent better system reselection (BSR) scan.

In another scenario, the event may be a silent redial scan. In this scenario, the wireless communication device 602 may create or update records in the database 614 using target communication systems 604 found during silent redial scanning The database population block/module 612 may create or update records in the database 614 that map the current communication system 604 (e.g., the first communication system 604) to the identified communication systems 604. In this scenario, the wireless communication device 602 may perform a subsequent silent redial scan by using the mapping 616 of the current (e.g., source) communication system 604 to other communication systems 604 previously identified during a silent redial scan. Therefore, the previously identified communication systems 604 may be prioritized (by the system search determination block/module 618, for instance) during a subsequent silent redial scan.

In yet another scenario, the event may be an off-frequency neighbor scan. In this scenario, the wireless communication device 602 may create or update records in the database 614 using communication systems 604 encountered during off-frequency neighbor scans. The database population block/module 612 may create or update records in the database 614 based on whether the neighboring communication system 604 has a chip-energy-to-total-interference ratio (E_{c}/I₀) above a threshold (e.g., −6 dB to −8 dB for CDMA). The chip-energy-to-total-interference ratio (E_{c}/Iₒ) threshold may indicate whether the neighboring communication system 604 is a useable communication system 604. The wireless communication device 602 may update or create records in this manner, for example, during an off-frequency scan on a CDMA2000 1x communication system 604 while in idle or traffic mode, or an off-frequency scan on an Evolution-Data Optimized (EV-DO) communication system while in idle or traffic mode.

In another scenario, the event may be concurrent camping on two communication systems 604 by a simultaneous voice and data (SV) device. The wireless communication device 602 may create or update records in the database 614 if the wireless communication device 602 is a simultaneous voice and data (SV) device. A simultaneous voice and data (SV) device may have two radios, one to access a voice network and one to access a data network. The database population block/module 612 may create or update records in the database 614 that map the associations between the voice and the data networks. For example, the record may map the system information (e.g., communication system 604, radio access technology (RAT), frequency, etc.) of the voice network that the wireless communication device 602 is currently camped on (e.g., connected to) to the system information (e.g., communication system 604, radio access technology (RAT), frequency, etc.) of the data network that the wireless communication device 602 is simultaneously (e.g., concurrently) camped on.

In another scenario, the event may be concurrent camping on two communication systems 604 by a dual-subscriber-identity-module (SIM), dual-standby (DSDS) device. A dual-subscriber-identity-module (SIM), dual-standby (DSDS) device may have two subscriptions and may be capable of receiving service on two communication systems 604 simultaneously. In this scenario, the database population block/module 612 may create or update records in the database 614 that map the system information (e.g., communication system 604, radio access technology (RAT), frequency, etc.) of the first communication system 604 to which the device subscribes to the system information (e.g., communication system 604, radio access technology (RAT), frequency, etc.) of the second communication system 604 to which the device subscribes. Further, each time the wireless communication device 602 discovers a usable communication system, the wireless communication device 602 may create a mapping 616 from the original camped communication system 604 to the newly discovered system. Therefore, a mapping 616 may be created between communication systems 604 discovered and/or camped on using subscription 1 and the communication systems 604 discovered and/or camped on using subscription 2.

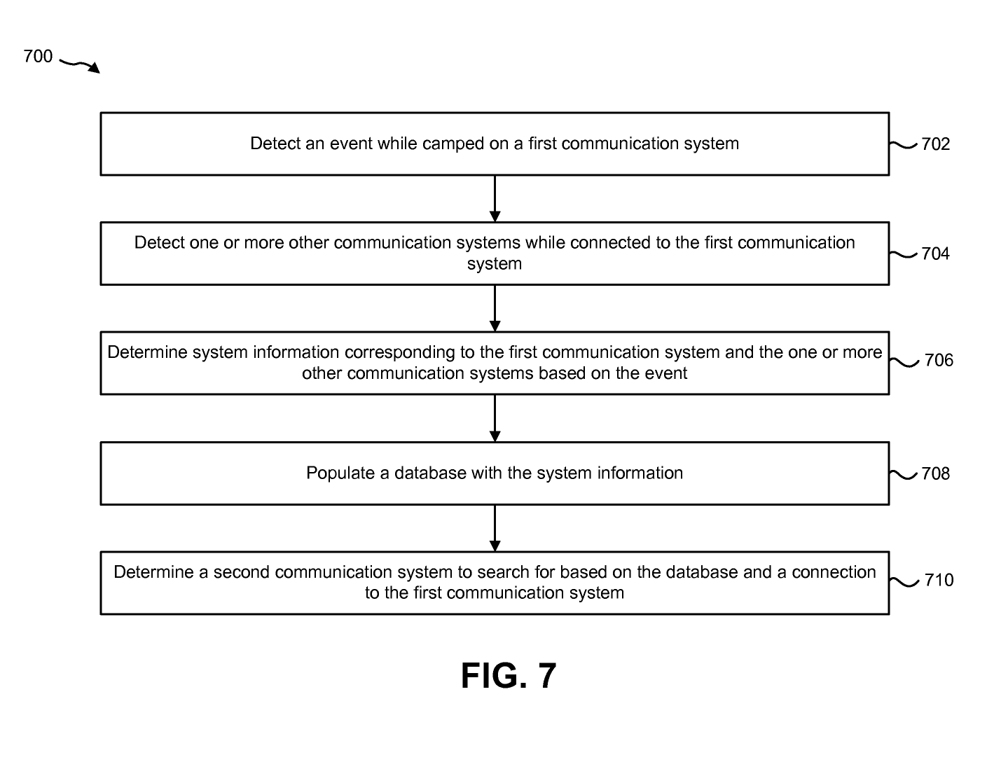

FIG. 7 is a flow diagram illustrating another configuration of a method 700 for creating and maintaining a database of communication systems 604. The method 700 may be performed by a wireless communication device 602. For example, the method 700 may be performed by a search management block/module 608. The wireless communication device 602 may detect 702 one or more events while camped on a first communication system 604. The events may include receiving a neighbor list message, redirection from a communication system, reselection of a communication system, a better system reselection (BSR) scan, a silent redial scan, an off-frequency scan, an acquisition scan and concurrent camping on two systems.

The wireless communication device 602 may detect 704 one or more other communication systems 604 while the wireless communication device 602 is connected to the first communication system 604. In some implementations, this may be done as described in connection with FIG. 2. In one configuration, the wireless communication device 602 may detect 704 the one or more other communication systems 604 based on the event. In one example, detecting 704 the one or more communication systems 604 may include the wireless communication device 602 receiving information about the one or more communication systems 604. For instance, the wireless communication device 602 may receive information about the one or more communication systems 604 by receiving a neighbor list message. In another example, detecting 704 the one or more communication systems 604 may include the wireless communication device 602 discovering the one or more communication systems 604. For instance, the wireless communication device 602 may perform a scan (e.g., a better system reselection (BSR) scan, a silent redial scan, an off-frequency scan, an acquisition scan, etc.) to discover one or more communication systems 604.

The wireless communication device 602 may determine 706 system information corresponding to the first communication system 604 and the one or more other communication systems 604 based on the event. For example, upon detecting 702 the event, the wireless communication device 602 may detect 704 the one or more other communication systems 604 while connected to the first communication system 604. The system information may include the frequency and radio access technologies (RATs) of the first communication system 604 and the other communication systems 604 detected 704 by the wireless communication device 602. The system information may also include the band (e.g., frequency band) used by the communication systems 104 and whether a communication system 604 is an evolved packet core (EPC) or non-evolved packet core (non-EPC) system. The system information may also indicate whether a communication system 604 is a third-generation (3G) or fourth-generation (4G) system. The system information may additionally include a timestamp of when the other communication systems 604 were detected 704 by the wireless communication device 602.

The wireless communication device 602 may populate 708 a database 614 with the system information. In some implementations, this may be done as described in connection with FIG. 2. The database 614 may include a mapping 616 between the first communication system 604 and the other communication systems 604.

The wireless communication device 602 may determine 710 a second communication system 604 to search for based on the database 614 and a connection to the first communication system 604. In some implementations, this may be done as described in connection with FIG. 2.

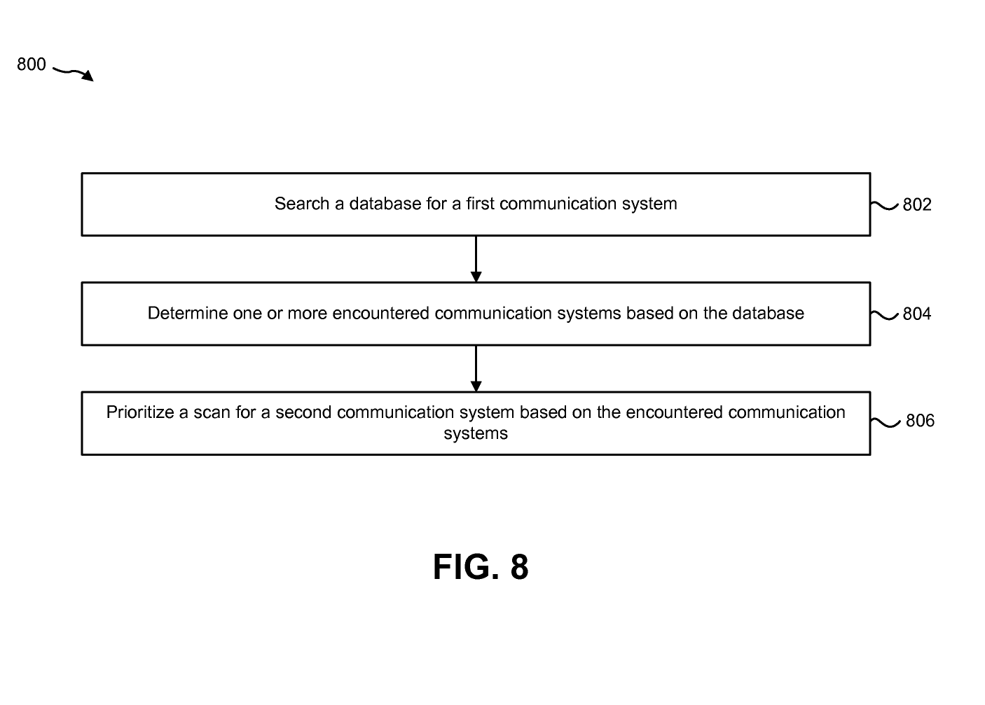

FIG. 8 is a flow diagram illustrating a configuration of a method 800 for determining a second communication system 104 to search for. The method 800 may be performed by a wireless communication device 102. The wireless communication device 102 may search 802 a database 114 for a first communication system 104. In one scenario, the wireless communication device 102 may currently be connected to the first communication system 104. In another scenario, the wireless communication device 102 may be disconnected from the first communication system 104. For example, the wireless communication device 102 may have recently been disconnected from the first communication system 104.

In one configuration, the search 802 may include a query sent to the database 114. The query may include system information corresponding to the first communication system 104.

The wireless communication device 102 may determine 804 one or more encountered communication systems 104 based on the database 114. For example, the query sent to the database 114 may be evaluated to determine 804 whether the wireless communication device 102 may have encountered other communication systems 104 while connected to the first communication system 104. In one configuration, upon receiving the query, the database 114 may identify whether one or more encountered communication systems 104 exist based on a mapping 116 in the database 114.

The wireless communication device 102 may prioritize 806 a scan for a second communication system 104 based on the encountered communication systems 104. For example, if the query results indicate that there are encountered communication systems 104 (e.g., the wireless communication device 102 has encountered the other communication systems 104 while connected to the first communication system 104), then the wireless communication device 102 may prioritize 806 the encountered communication systems 104 in a scan for the second communication system 104. In other words, the wireless communication device 102 may search for the one or more communication systems 104 that were previously encountered while connected to the first communication system 104 before conducting a broad search for available communication systems 104.

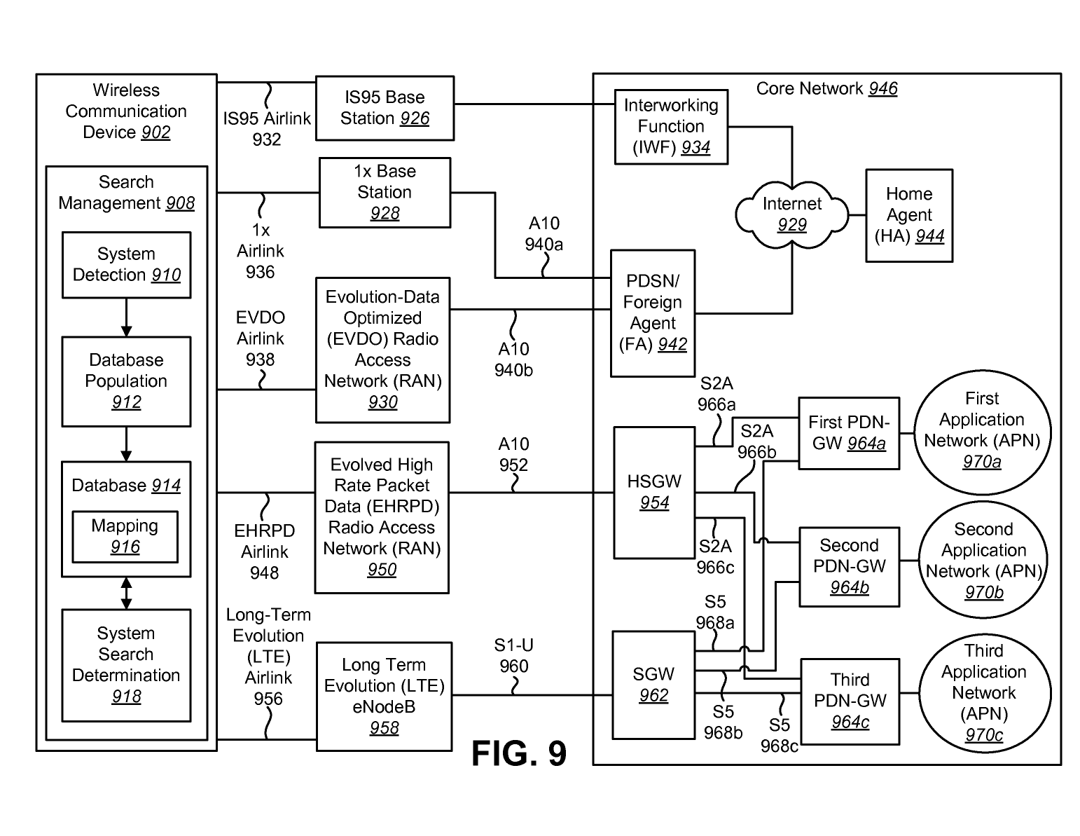

FIG. 9 is a block diagram illustrating various types of connectivity between a wireless communication device 902 and a core network 946 that the wireless communication device 902 may utilize for data services and/or voice services. The wireless communication device 902 of FIG. 9 may be one example of the wireless communication device 102 of FIG. 1. For example, the wireless communication device 902 may include a search management block/module 908. The search management block/module 908 may include a system detection block/module 910, a database population block/module 912, a database 914 with one or more mappings 916 and/or a system search determination block/module 918 similar to corresponding elements described above.

Multiple air interfaces (or airlinks) may provide a data connection for a wireless communication device 902 to the Internet 929 via an Interim Standard 95 (IS95) base station 926, a CDMA 2000 1x (1x) base station 928 and/or an Evolution-Data Optimized (EVDO) radio access network (RAN) 930. The IS95 base station 926 may provide an IS95 airlink 932 for the wireless communication device 902. The IS95 base station 926 may be connected to the Internet 929 via an InterWorking Function (IWF) 934. The 1x base station 928 may provide a 1x airlink 936 to the wireless communication device 902. The Evolution-Data Optimized (EVDO) radio access network (RAN) 930 may provide an Evolution-Data Optimized (EVDO) airlink 938 to the wireless communication device 902. The 1x base station 928 and Evolution-Data Optimized (EVDO) radio access network (RAN) 930 may be connected via A10 interfaces 940a-b to a Packet Data Serving Node (PDSN) 942, which in turn is connected to the Internet 929. The Packet Data Serving Node (PDSN) 942 may include a Foreign Agent (FA). A Home Agent (HA) 944 may be connected to the Internet 929.

The network architecture may include data connectivity via the evolved high rate packet data (eHRPD) airlink 948 and an evolved high rate packet data (eHRPD) radio access network (RAN) 950 to the core network 946. The evolved high rate packet data (eHRPD) radio access network (RAN) 950 may employ an A10 interface 952 to connect to an HRPD Serving Gateway (HSGW) 954. The network architecture may also include data connectivity via the Long Term Evolution (LTE) airlink 956 and Long Term Evolution (LTE) eNodeB 958. The Long Term Evolution (LTE) eNodeB 958 may employ an S1-U interface 960 to connect to a Serving Gateway (SGW) 962. The HRPD Serving Gateway (HSGW) 954 may connect to a first Packet Data Network Gateway (PDN-GW) 964a, a second Packet Data Network Gateway (PDN-GW) 964b and a third Packet Data Network Gateway (PDN-GW) 964c via S2A interfaces 966a-c.

The Serving Gateway (SGW) 962 may connect with the first Packet Data Network Gateway (PDN-GW) 964a, the second Packet Data Network Gateway (PDN-GW) 964b and the third Packet Data Network Gateway (PDN-GW) 964c via S5 interfaces 968a-c. The first Packet Data Network Gateway (PDN-GW) 964a may connect to a first Application Network (APN) 970a. The second Packet Data Network Gateway (PDN-GW) 964b may connect to a second Application Network (APN) 970b. The third Packet Data Network Gateway (PDN-GW) 964c may connect to a third Application Network (APN) 970c. An Application Network (APN) 970 may include, but is not limited to, an Internet Multimedia System (IMS) that a wireless communication device 902 connects to for obtaining Voice over IP (VoIP) or video telephony services or an Administrative Application Network (APN) the wireless communication device 902 may establish a connection with in order to download configuration information for the wireless communication device 902.

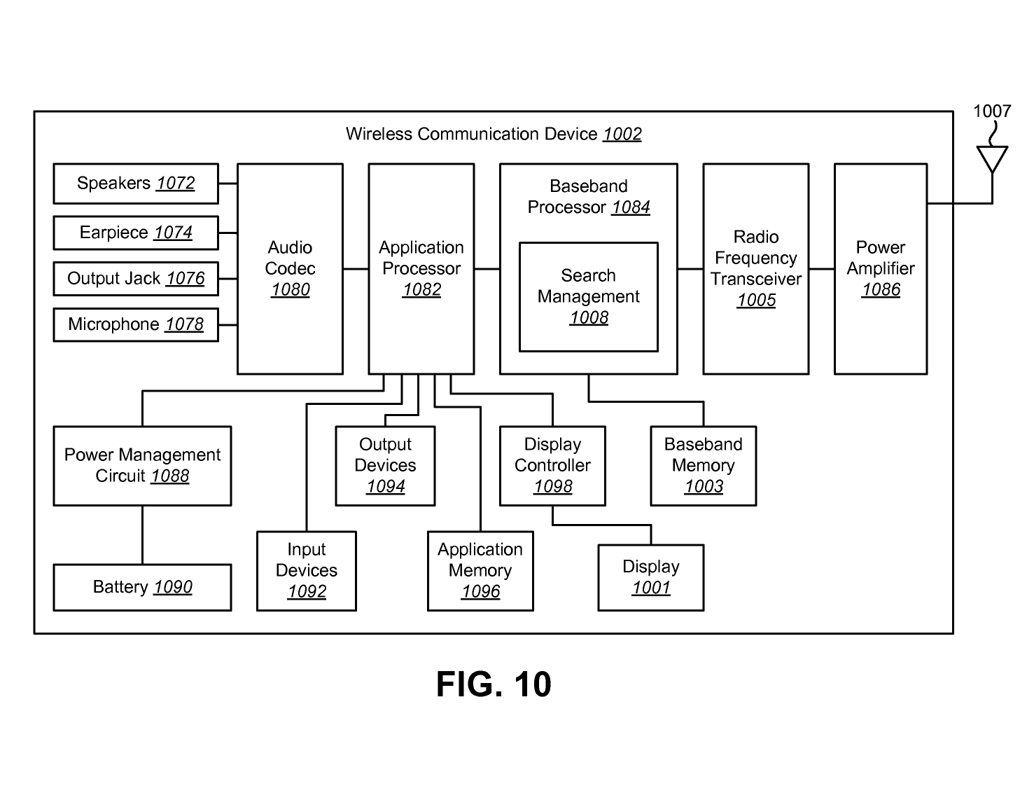

FIG. 10 is a block diagram illustrating one configuration of a wireless communication device 1002 in which systems and methods for creating and maintaining a database of communication systems 104 may be implemented. The wireless communication device 1002 illustrated in FIG. 10 may include one or more of the wireless communication devices 102, 402, 502, 602, 902 and/or other devices/circuitries described above. The wireless communication device 1002 may include an application processor 1082. The application processor 1082 generally processes instructions (e.g., runs programs) to perform functions on the wireless communication device 1002. The application processor 1082 may be coupled to an audio coder/decoder (codec) 1080.

The audio codec 1080 may be an electronic device (e.g., integrated circuit) used for coding and/or decoding audio signals. The audio codec 1080 may be coupled to one or more speakers 1072, an earpiece 1074, an output jack 1076 and/or one or more microphones 1078. The speakers 1072 may include one or more electro-acoustic transducers that convert electrical or electronic signals into acoustic signals. For example, the speakers 1072 may be used to play music or output a speakerphone conversation, etc. The earpiece 1074 may be another speaker or electro-acoustic transducer that can be used to output acoustic signals (e.g., speech signals) to a user. For example, the earpiece 1074 may be used such that only a user may reliably hear the acoustic signal. The output jack 1076 may be used for coupling other devices to the wireless communication device 1002 for outputting audio, such as headphones. The speakers 1072, earpiece 1074 and/or output jack 1076 may generally be used for outputting an audio signal from the audio codec 1080. The one or more microphones 1078 may be acousto-electric transducer that converts an acoustic signal (such as a user's voice) into electrical or electronic signals that are provided to the audio codec 1080.

The application processor 1082 may also be coupled to a power management circuit 1088. One example of a power management circuit 1088 is a power management integrated circuit (PMIC), which may be used to manage the electrical power consumption of the wireless communication device 1002. The power management circuit 1088 may be coupled to a battery 1090. The battery 1090 may generally provide electrical power to the wireless communication device 1002. For example, the battery 1090 and/or the power management circuit 1088 may be coupled to one or more of the elements included in the wireless communication device 1002.

The application processor 1082 may be coupled to one or more input devices 1092 for receiving input. Examples of input devices 1092 include infrared sensors, image sensors, accelerometers, touch sensors, keypads, etc. The input devices 1092 may allow user interaction with the wireless communication device 1002. The application processor 1082 may also be coupled to one or more output devices 1094. Examples of output devices 1094 include printers, projectors, screens, haptic devices, etc. The output devices 1094 may allow the wireless communication device 1002 to produce output that may be experienced by a user.

The application processor 1082 may be coupled to application memory 1096. The application memory 1096 may be any electronic device that is capable of storing electronic information. Examples of application memory 1096 include double data rate synchronous dynamic random access memory (DDRAM), synchronous dynamic random access memory (SDRAM), flash memory, etc. The application memory 1096 may provide storage for the application processor 1082. For instance, the application memory 1096 may store data and/or instructions for the functioning of programs that are run on the application processor 1082.

The application processor 1082 may be coupled to a display controller 1098, which in turn may be coupled to a display 1001. The display controller 1098 may be a hardware block that is used to generate images on the display 1001. For example, the display controller 1098 may translate instructions and/or data from the application processor 1082 into images that can be presented on the display 1001. Examples of the display 1001 include liquid crystal display (LCD) panels, light emitting diode (LED) panels, cathode ray tube (CRT) displays, plasma displays, etc.

The application processor 1082 may be coupled to a baseband processor 1084. The baseband processor 1084 generally processes communication signals. For example, the baseband processor 1084 may demodulate and/or decode received signals. Additionally or alternatively, the baseband processor 1084 may encode and/or modulate signals in preparation for transmission.

The baseband processor 1084 may be coupled to baseband memory 1003. The baseband memory 1003 may be any electronic device capable of storing electronic information, such as SDRAM, DDRAM, flash memory, etc. The baseband processor 1084 may read information (e.g., instructions and/or data) from and/or write information to the baseband memory 1003. Additionally or alternatively, the baseband processor 1084 may use instructions and/or data stored in the baseband memory 1003 to perform communication operations.

The baseband processor 1084 may include a search management block/module 1008 for creating and maintaining a database of communication systems 104 according to the systems and methods disclosed herein. The search management block/module 1008 may be configured similarly to one or more of the search management blocks/modules 108, 608, 508, 608, 908 described herein. Additionally or alternatively, the search management block/module 1008 may perform one or more of the methods 200, 700, 800 and/or one or more of the functions described in connection with one or more of the search management blocks/modules 108, 608, 508, 608, 908 described above. In some configurations, the search management block/module 1008 may be alternatively implemented independently from the baseband processor 1084.

The baseband processor 1084 may be coupled to a radio frequency (RF) transceiver 1005. The RF transceiver 1005 may be coupled to a power amplifier 1086 and one or more antennas 1007. The RF transceiver 1005 may transmit and/or receive radio frequency signals. For example, the RF transceiver 1005 may transmit an RF signal using a power amplifier 1086 and one or more antennas 1007. The RF transceiver 1005 may also receive RF signals using the one or more antennas 1007.

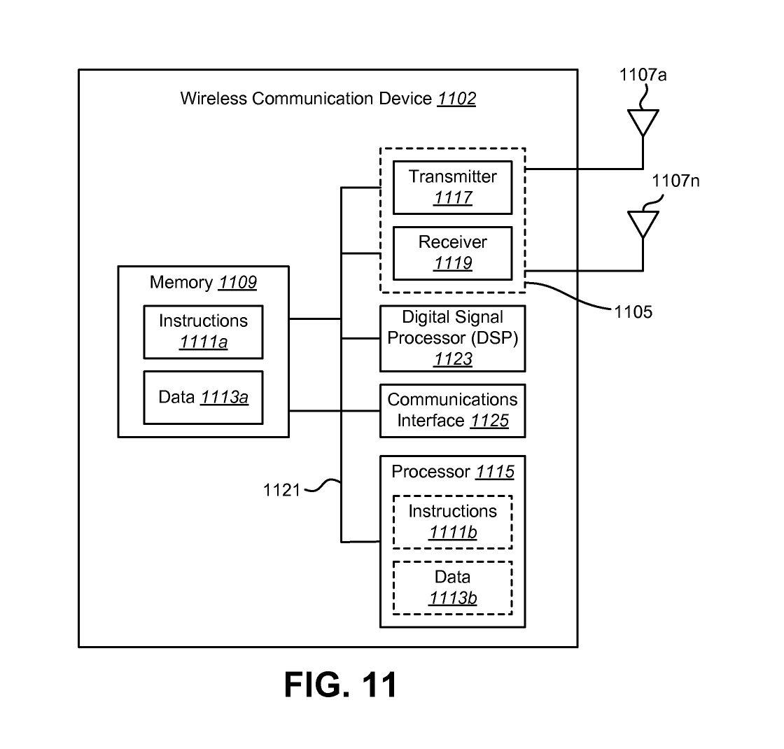

FIG. 11 illustrates certain components that may be included within a wireless communication device 1102. The wireless communication device 1102 may be implemented in accordance with one or more of the wireless communication devices 102, 402, 502, 602, 902 and 1002 described above. The wireless communication device 1102 may be an access terminal, a mobile station, a user equipment, etc. The wireless communication device 1102 includes a processor 1115. The processor 1115 may be a general purpose single- or multi-chip microprocessor (e.g., an ARM), a special purpose microprocessor (e.g., a digital signal processor (DSP)), a microcontroller, a programmable gate array, etc. The processor 1115 may be referred to as a central processing unit (CPU). Although just a single processor 1115 is shown in the wireless communication device 1102 of FIG. 11, in an alternative configuration, a combination of processors (e.g., an ARM and DSP) could be used.

The wireless communication device 1102 also includes memory 1109. The memory 1109 may be any electronic component capable of storing electronic information. The memory 1109 may be embodied as random access memory (RAM), read-only memory (ROM), magnetic disk storage media, optical storage media, flash memory devices in RAM, on-board memory included with the processor, erasable programmable read-only memory (EPROM), electrically erasable PROM (EEPROM), registers and so forth, including combinations thereof.

Data 1113a and instructions 1111a may be stored in the memory 1109. The instructions 1111a may be executable by the processor 1115 to implement the methods disclosed herein. Executing the instructions 1111a may involve the use of the data 1113a that is stored in the memory 1109. When the processor 1115 executes the instructions 1111a, various portions of the instructions 1111b may be loaded onto the processor 1115, and various pieces of data 1113b may be loaded onto the processor 1115.

The wireless communication device 1102 may also include a transmitter 1117 and a receiver 1119 to allow transmission and reception of signals to and from the wireless communication device 1102. The transmitter 1117 and receiver 1119 may be collectively referred to as a transceiver 1105. Multiple antennas 1107a-n may be electrically coupled to the transceiver 1105. The wireless communication device 1102 may also include (not shown) multiple transmitters, multiple receivers, multiple transceivers and/or additional antennas.

The wireless communication device 1102 may include a digital signal processor (DSP) 1123. The wireless communication device 1102 may also include a communications interface 1125. The communications interface 1125 may allow a user to interact with the wireless communication device 1102.

The various components of the wireless communication device 1102 may be coupled together by one or more buses, which may include a power bus, a control signal bus, a status signal bus, a data bus, etc. For the sake of clarity, the various buses are illustrated in FIG. 11 as a bus system 1121.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The techniques described herein may be used for various communication systems, including communication systems that are based on an orthogonal multiplexing scheme. Examples of such communication systems include orthogonal frequency division multiple access (OFDMA) systems, single-carrier frequency division multiple access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “couple” and any variations thereof may indicate a direct or indirect connection between elements. For example, a first element coupled to a second element may be directly connected to the second element, or indirectly connected to the second element through another element.

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2, 7 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for creating and maintaining a database of communication systems by a wireless communication device, comprising:
detecting one or more other communication systems while connected to a first communication system;
populating a database with system information corresponding to the first communication system and the one or more other communication systems, wherein the database comprises a mapping between the first communication system and the one or more other communication systems; and
determining a second communication system to search for based on the database and a connection to the first communication system.

2. The method of claim 1, further comprising:
detecting an event while camped on the first communication system;
determining the system information based on the event; and
determining the mapping between the first communication system and the one or more other communication systems based on the system information.

3. The method of claim 2, wherein the event comprises at least one of receiving a neighbor list message, redirection from a communication system, cell reselection from a communication system, a better system reselection scan, a high priority system scan, a connected mode handover, a silent redial scan, an off-frequency scan, an acquisition scan and concurrent camping on two systems.

4. The method of claim 1, wherein the system information comprises a frequency and a radio access technology for the first communication system and a frequency and a radio access technology for the one or more other communication systems found during an event.

5. The method of claim 1, wherein the system information comprises at least one of a band, whether a communication system is an evolved packet core system, a radio access technology of a communication system, a timestamp and an association probability.

6. The method of claim 1, further comprising determining an association probability for each mapping in the database, wherein an association probability is related to a number of samples collected that support the mapping.

7. The method of claim 1, wherein the wireless communication device accesses the first communication system using a first subscription and the one or more other communication systems using a second subscription.

8. The method of claim 1, wherein the first communication system comprises a voice communication system and at least one or more other communication systems comprise data communication systems or voice communication systems.

9. The method of claim 1, wherein the first communication system comprises a data communication system and at least one or more other communication systems comprise data communication systems or voice communication systems.

10. The method of claim 1, further comprising maintaining the database on the wireless communication device indefinitely.

11. The method of claim 1, wherein determining the second communication system to search for based on the database and a connection to the first communication system comprises:
searching the database for the first communication system;
determining one or more encountered communication systems based on the database; and
prioritizing a scan for the second communication system based on the encountered communication systems.

12. A wireless communication device for creating and maintaining a database of communication systems, comprising:
system detection circuitry that detects one or more other communication systems while connected to a first communication system;
database population circuitry coupled to the system detection circuitry, wherein the database population circuitry populates a database with system information corresponding to the first communication system and the one or more other communication systems, and wherein the database comprises a mapping between the first communication system and the one or more other communication systems; and
system search determination circuitry that determines a second communication system to search for based on the database and a connection to the first communication system.

13. The wireless communication device of claim 12, further comprising:
event detection circuitry coupled to the system detection circuitry, wherein the event detection circuitry detects an event while camped on the first communication system; and
system information determination circuitry coupled to the system detection circuitry, wherein the system information circuitry determines the system information based on the event, and wherein the database population circuitry determines the mapping between the first communication system and the one or more other communication systems based on the system information.

14. The wireless communication device of claim 13, wherein the event comprises at least one of receiving a neighbor list message, redirection from a communication system, cell reselection from a communication system, a better system reselection scan, a high priority system scan, a connected mode handover, a silent redial scan, an off-frequency scan, an acquisition scan and concurrent camping on two systems.

15. The wireless communication device of claim 12, wherein the system information comprises a frequency and a radio access technology for the first communication system and a frequency and a radio access technology for the one or more other communication systems found during an event.

16. The wireless communication device of claim 12, wherein the system information comprises at least one of a band, whether a communication system is an evolved packet core system, a radio access technology of a communication system, a timestamp and an association probability.

17. The wireless communication device of claim 12, wherein the database population circuitry further determines an association probability for each mapping in the database, and wherein an association probability is related to a number of samples collected that support the mapping.

18. The wireless communication device of claim 12, wherein the wireless communication device accesses the first communication system using a first subscription and the one or more other communication systems using a second subscription.

19. The wireless communication device of claim 12, wherein the first communication system comprises a voice communication system and at least one or more other communication systems comprise data communication systems or voice communication systems.

20. The wireless communication device of claim 12, wherein the first communication system comprises a data communication system and at least one or more other communication systems comprise data communication systems or voice communication systems.

21. The wireless communication device of claim 12, further comprising maintaining the database on the wireless communication device indefinitely.

22. The wireless communication device of claim 12, wherein the system search determination circuitry searches the database for the first communication system, determines one or more encountered communication systems based on the database and prioritizes a scan for the second communication system based on the encountered communication systems.

23. A computer-program product for creating and maintaining a database of communication systems, comprising a non-transitory tangible computer-readable medium having instructions thereon, the instructions comprising:
code for causing a wireless communication device to detect one or more other communication systems while connected to a first communication system;
code for causing the wireless communication device to populate a database with system information corresponding to the first communication system and the one or more other communication systems, wherein the database comprises a mapping between the first communication system and the one or more other communication systems; and
code for causing the wireless communication device to determine a second communication system to search for based on the database and a connection to the first communication system.

24. The computer-program product of claim 23, further comprising:
code for causing the wireless communication device to detect an event while camped on the first communication system;
code for causing the wireless communication device to determine the system information based on the event; and
code for causing the wireless communication device to determine the mapping between the first communication system and the one or more other communication systems based on the system information.

25. The computer-program product of claim 24, wherein the event comprises at least one of receiving a neighbor list message, redirection from a communication system, cell reselection from a communication system, a better system reselection scan, a high priority system scan, a connected mode handover, a silent redial scan, an off-frequency scan, an acquisition scan and concurrent camping on two systems.

26. The computer-program product of claim 23, wherein the system information comprises a frequency and a radio access technology for the first communication system and a frequency and a radio access technology for the one or more other communication systems found during an event.

27. The computer-program product of claim 23, wherein the system information comprises at least one of a band, whether a communication system is an evolved packet core system, a radio access technology of a communication system, a timestamp and an association probability.

28. The computer-program product of claim 23, further comprising code for causing the wireless communication device to determine an association probability for each mapping in the database, wherein an association probability is related to a number of samples collected that support the mapping.

29. The computer-program product of claim 23, wherein the wireless communication device accesses the first communication system using a first subscription and the one or more other communication systems using a second subscription.

30. The computer-program product of claim 23, wherein the first communication system comprises a voice communication system and at least one or more other communication systems comprise data communication systems or voice communication systems.

31. The computer-program product of claim 23, wherein the first communication system comprises a data communication system and at least one or more other communication systems comprise data communication systems or voice communication systems.

32. The computer-program product of claim 23, further comprising code for causing the wireless communication device to maintain the database on the wireless communication device indefinitely.

33. The computer-program product of claim 23, wherein the code for causing the wireless communication device to determine a second communication system to search for based on the database and a connection to the first communication system comprises:
code for causing the wireless communication device to search the database for the first communication system;
code for causing the wireless communication device to determine one or more encountered communication systems based on the database; and
code for causing the wireless communication device to prioritize a scan for the second communication system based on the encountered communication systems.

34. An apparatus for creating and maintaining a database of communication systems, comprising:
means for detecting one or more other communication systems while connected to a first communication system;
means for populating a database with system information corresponding to the first communication system and the one or more other communication systems, wherein the database comprises a mapping between the first communication system and the one or more other communication systems; and
means for determining a second communication system to search for based on the database and a connection to the first communication system.

35. The apparatus of claim 34, further comprising:
means for detecting an event while camped on the first communication system;
means for determining the system information based on the event; and
means for determining the mapping between the first communication system and the one or more other communication systems based on the system information.

36. The apparatus of claim 35, wherein the event comprises at least one of receiving a neighbor list message, redirection from a communication system, cell reselection from a communication system, a better system reselection scan, a high priority system scan, a connected mode handover, a silent redial scan, an off-frequency scan, an acquisition scan and concurrent camping on two systems.

37. The apparatus of claim 34, wherein the system information comprises a frequency and a radio access technology for the first communication system and a frequency and a radio access technology for the one or more other communication systems found during an event.

38. The apparatus of claim 34, wherein the system information comprises at least one of a band, whether a communication system is an evolved packet core system, a radio access technology of a communication system, a timestamp and an association probability.

39. The apparatus of claim 34, further comprising means for determining an association probability for each mapping in the database, wherein an association probability is related to a number of samples collected that support the mapping.

40. The apparatus of claim 34, wherein the apparatus accesses the first communication system using a first subscription and the one or more other communication systems using a second subscription.

41. The apparatus of claim 34, wherein the first communication system comprises a voice communication system and at least one or more other communication systems comprise data communication systems or voice communication systems.

42. The apparatus of claim 34, wherein the first communication system comprises a data communication system and at least one or more other communication systems comprise data communication systems or voice communication systems.

43. The apparatus of claim 34, further comprising means for maintaining the database on the apparatus indefinitely.

44. The apparatus of claim 34, wherein the means for determining the second communication system to search for based on the database and a connection to the first communication system comprises:
means for searching the database for the first communication system;
means for determining one or more encountered communication systems based on the database; and
means for prioritizing a scan for the second communication system based on the encountered communication systems.
